(19) United States
(12) Patent Application Publication
(10) Pub. No.: US 2025/0270460 A1
(43) Pub. Date: Aug. 28, 2025

(54) METHOD OF PRODUCING SYNGAS FROM BIOMASS UTILIZING TAIL GAS FOR TAR REMOVAL

(71) Applicant: MOTE, INC., Los Angeles, CA (US)

(72) Inventors: Joshuah STOLAROFF, Los Angeles, CA (US); Alison CHEN, Spring, TX (US)

(73) Assignee: MOTE, INC., Los Angeles, CA (US)

(21) Appl. No.: 18/856,937

(22) PCT Filed: Apr. 14, 2023
(86) PCT No.: PCT/US2023/018737

§ 371 Date: Oct. 15, 2024

Related U.S. Application Data
(60) Provisional application No. 63/331,606, filed on Apr. 15, 2022.
(60) Provisional application No. 63/333,773, filed on Apr. 22, 2022.

(51) Int. Cl. C10J 3/84; C01B 3/02; C10J 3/20

(52) U.S. Cl. CPC C10J 3/84; C01B 3/02; C10J 3/20

(57) ABSTRACT

A system and method for the generation of syngas from the gasification of biomass is disclosed herein. Some aspects of the disclosure are directed to a biomass gasification method that employs a tail gas by-product as a fuel.

### CROSS REFERENCE TO RELATED APPLICATIONS

This application claims the benefit of priority to U.S. Provisional Patent Application Ser. No. 63/331,606, filed Apr. 15, 2022, and U.S. Provisional Patent Application Ser. No. 63/333,773, filed Apr. 22, 2022, each of which are incorporated by reference herein in their entirety.

### BACKGROUND AND FIELD

### I. Field

This disclosure and the associated invention(s) relate at least to the field of renewable fuels production, and in particular, systems and methods for carrying out biomass gasification.

### II. Background

Gasification is a pathway that uses a partial oxidation process involving heat, steam, and oxygen (or air) to convert any carbonaceous raw material such as biomass into synthesis gas (syngas for short). The syngas consists primarily of hydrogen (H₂), carbon monoxide (CO), and carbon dioxide (CO₂), and it can be further processed and converted into a wide range of products such as hydrogen, ammonia, methanol, gasoline, aviation fuel, and electricity. Carbon from the process may be captured and stored for use.

This patent will focus primarily on biomass gasification for hydrogen production, but it can be applied to other fuel or chemical productions. Biomass, a renewable organic resource, includes agriculture crop residues, forest residues, special crops grown specifically for energy use (such as switchgrass or willow trees), municipal solid waste, and animal wastes. This renewable resource can be used to produce syngas, along with other byproducts, via gasification.

During gasification, the biomass is converted at high temperatures (e.g., >700° C.), using a controlled amount of oxygen (or air) and steam, into syngas. For the purpose of maximizing hydrogen production, water gas shift reactors are used downstream of gasification to convert carbon monoxide and water to carbon dioxide and more hydrogen. Acid gas, namely hydrogen sulfide (H₂S) and carbon dioxide (CO₂), is removed from the syngas in the subsequent syngas cleanup section. High purity hydrogen is separated from the clean syngas stream using pressure swing adsorption (PSA) or special membranes. The remaining tail gas can be utilized to generate steam and/or power.

Problems with existing biomass gasification processes include the formation of tar as a by-product from the gasification process, in particular at levels higher than the tar tolerance levels of downstream systems. The removal or reduction of tar, which refers to organic compounds with molecular weight higher than benzene, is a significant challenge. As such, there are needs for improved methods and systems for removing tar during the gasification process of biomass feeds.

The present invention(s) overcome these issues and others as will be explained in detail below.

### SUMMARY OF THE INVENTION

In a conventional oxygen-blown biomass gasification system with thermal destruction (or thermal cracking) of tar, approximately 4-14% of the syngas produced is used as fuel for the tar removal (or tar burner) system. If natural gas is available, it can also be used as fuel for the tar removal system, in conjunction with syngas or by itself. The present inventors have discovered that by providing at least a portion of the tail gas by-product from post-gasification process to the tar removal system of the syngas generation system, the net amount of syngas used to produce hydrogen or other end product(s) is increased. In a process model where the tar removal system was configured to use tail gas instead of syngas as fuel source, the amount of hydrogen produced at PSA outlet increased by 8-11%. Tail gas is oftentimes a low-value by-product that is burned and released to the atmosphere. Therefore, the tail gas by-product can be harnessed as an alternative, lower-value replacement for higher-value natural gas or recycled syngas.

Some aspects of the disclosure are therefore directed to a biomass gasification method that employs a tail gas by-product as a fuel. In some aspects, the method comprises receiving and preparing biomass system, feeding biomass at biomass feed inlet(s) of a syngas generation system; gasifying, using one or more gasifier of the syngas generation system under a condition resulting in generation of a tar by-product, the syngas generation system including a tar removal system configured to remove the tar by-product from the syngas; a post-gasification process including a separation or purification system resulting in generation of a tail gas by-product; providing at least a portion of the tail gas by-product to the tar removal system of the syngas generation system; and operating the tar removal system using at least a portion of the tail gas by-product as fuel to remove or reduce the tar in the syngas.

In some aspects, the method further comprises increasing the concentration of at least one tail gas by-product component by a separation process prior to providing at least a portion of the tail gas by-product to the tar removal system of the syngas generation system. In some aspects, increasing the concentration of at least one tail gas by-product component comprises employing a separation technique selected from pressure swing adsorption (PSA), cryogenic distillation, and membrane separation. In some aspects, the increased-concentration component is an oxidizable component. In some aspects, the oxidizable component is selected from hydrogen, carbon monoxide, and a combination thereof.

In some aspects, the tail gas by-product provided to the tar removal system of the syngas generation system is not subjected to a component concentration-increasing step. In other words, raw, unprocessed tail gas is recycled to the tar removal system.

In some aspects, providing at least a portion of the tail gas by-product to the tar removal system is performed in lieu of or in addition to natural gas or recycling syngas to the tar removal system.

Some aspects of the disclosure are directed to a synthesis gas (syngas) generation system. In some aspects, the syngas generation system comprises a biomass feed inlet configured to receive a biomass feed, a gasifier in communication with the biomass feed inlet and configured to receive and gasify the biomass feed to produce syngas under a condition resulting in generation of a tar by-product, a post-gasification process including a separation or purification system resulting in generation of a tail gas by-product, and a transport system configured to transport the tail gas by-product to a tar removal system within the syngas generation system, where the tar removal system is configured to use the tail-gas byproduct received via the transport system as fuel to process the syngas to remove the tar by-product from the syngas.

In some aspects, the transport system comprises a component-separation apparatus to increase the concentration of at least one tail gas by-product component by a separation process. In some aspects, the component-separation apparatus increases the concentration of at least one tail gas by-product component by employing a separation technique selected from pressure swing adsorption (PSA), cryogenic distillation, and membrane separation. In some aspects, the increased-concentration component is an oxidizable component. In some aspects, the oxidizable component is selected from hydrogen, carbon monoxide, and a combination thereof. In some aspects, the system does not comprise a component-separation apparatus to increase the concentration of at least one tail gas by-product component. In some aspects, the transport system enables the syngas generation system to produce an increased net amount of syngas for post-gasification process as compared to a comparable syngas generation system lacking a tail gas transport system.

As used herein, various terminology is used for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes 0.1, 1, 5, and 10 percent.

Throughout this application, the term “about” is used to indicate that a value includes the inherent variation of error for the measurement or quantitation method. In various embodiments, as used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to ±15%, ±10%, ±5%, or ±1% as understood by a person of skill in the art.

The use of the word “a” or “an” when used in conjunction with the term “comprising” may mean “one,” but it is also consistent with the meaning of “one or more,” “at least one,” and “one or more than one.”

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention(s). Any implementation of any of the systems, methods, apparatus, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Apparatus, systems, and methods “consisting essentially of” any of the components, apparatus, or steps disclosed limits the scope of the claim to the specified materials or steps which do not materially affect the basic and novel characteristic of the claimed implementation. Additionally, the term “wherein” may be used interchangeably with “where”.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention(s). Invention(s) may be better understood by reference to one or more of these drawings in combination with the detailed description of specific embodiments presented herein.

FIG. 1 is a schematic representations of a syngas generation process using biomass to ultimately produce hydrogen while capturing carbon dioxide (CO₂). The process includes a syngas generation system that utilizes tail gas as fuel for removing tar, in accordance with an embodiment of the present disclosure.

FIG. 2 is a schematic representations of a syngas generation process by a syngas generation system that utilizes tail gas as fuel for removing tar, in accordance with an embodiment of the present disclosure.

### DETAILED DESCRIPTION

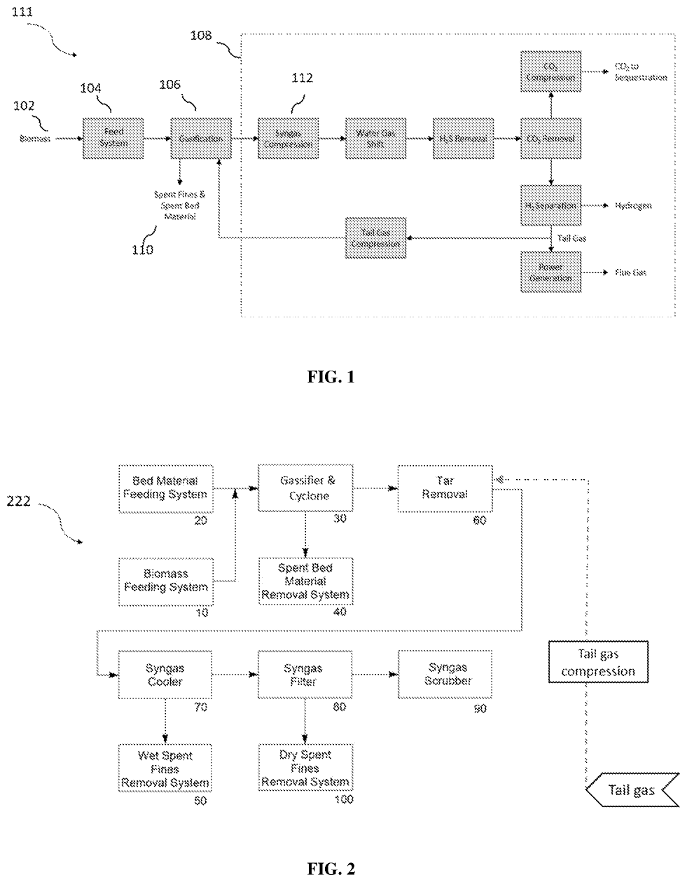

With reference to FIGS. 1 and 2, shown is a syngas generation process by a syngas generation system for gasifying biomass to ultimately produce hydrogen (H₂), with removal of fines, hydrogen sulfide (H₂S), and other contaminants. In some aspects, gaseous carbon dioxide (CO₂) may be removed. In some aspects, the gaseous CO₂ may be compressed and optionally further utilized and/or sequestered.

The syngas generation process begins with preparation of a biomass feed to be utilized to produce syngas. The biomass may include one or more of the following: forest biomass such as branches, brushes, etc., from forest management, sawmill residue, or shrub and chaparral; agricultural residues such as, but not limited to, nut shells and orchard trimmings; ocean waste, such as but not limited to algae, seaweed, etc.; urban waste such as, but not limited to, dry municipal solid waste, construction wood, green waste, etc.; or may originate from crops such as sawgrass specifically grown to be utilized as biomass.

FIG. 1 shows a schematic representation of a syngas generation process using biomass to ultimately produce hydrogen (H₂) while capturing carbon dioxide (CO₂). The process uses tail gas as fuel for removing tar, in accordance with various embodiments of the present disclosure. In various embodiments, the syngas generation process 111 includes the preparation 102 of biomass feed for feeding 104 into a gasifier for gasification 106 of the biomass feed to generate syngas. The gasification process 106 also includes cyclone(s), tar removal, syngas cooling, syngas filtering, syngas scrubbing, etc., as well as the handling and removal 110 of wet spent fines (or ash or slag), dry spent fines (or ash or slag), spent bed material, etc. Discussions related to the preparation 102 of the biomass feed, the feeding 104 of the biomass to the gasifier, the gasification 106 of the biomass, as well as the handling and removal 110 of the spent materials are provided with reference to FIG. 2, which includes more details of the noted processes. In various embodiments, the biomass feed preparation process 102 and biomass feeding 104 of FIG. 1 are performed by the biomass feeding system 10 and the bed material feeding system 20 of FIG. 2, the gasification 106 of FIG. 1 is performed by the gasifier and cyclone 30, the tar removal system 60, the syngas cooler 70, the syngas filter 80, and the syngas scrubber 90 of FIG. 2, and the handling and removal processes 110 of FIG. 1 are performed by the wet spent fines removal system 50, the dry spent fines removal system 100, and the spent bed material removal system 40 of FIG. 2.

With reference to FIG. 2, in various embodiments, the syngas generation system 222 includes a biomass feeding system 10 that includes one or more lock-hopper-based feeding lines that feed the biomass to the gasifier 30. Multiple feeding lines can be arranged in parallel, and one or more of them can be designed to feed biomass at even higher capacity than the intake capacity of the gasifier 30 (e.g., for a gasifier system with a capacity of about 350 short ton per day, or sTPD, each of the one or more feeding lines can be designed to feed biomass at about 114% of the total 350 sTPD feedstock, or about 400 sTPD capacity per feed train). Multiple parallel, full capacity feeding lines improve the reliability of the syngas generation system 222 in the event that a feeding line is taken offline for maintenance.

The biomass feed can be transported to the syngas generation system 222 via flight chain conveyor. The biomass feeding system 10 starts with a biomass distribution screw conveyor located at the top of the biomass feeding system 10. This conveyor delivers the biomass to the one or more feeding lines as follows. The biomass is dropped from the biomass distribution screw conveyor into the biomass storage silo, which is purged with an inert gas such as nitrogen to avoid dust explosion or self-ignition of the dried fuel. From the storage silo, the fuel is moved through the biomass storage silo discharger and biomass distribution screw into one or more (e.g., two) lock hoppers, where the biomass feedstock pressure is alternately increased from atmospheric pressure to system pressure with an inert gas such as nitrogen and/or carbon dioxide. It is then discharged to the biomass surge hopper as described below and depressurized to begin the fill step. From the pressurized lock hoppers, the biomass is fed to biomass surge hopper with live bottom screws via lock hopper discharger. The biomass is fed from the surge hoppers through the metering screw conveyor to the biomass feeding screw conveyor that feeds the biomass into the gasifier 30.

In various embodiments, the syngas generation system 222 includes a bed material feeding system 20 that includes a bed material storage silo for storing a bed material (e.g., dolomite). In some instances, the bed material feeding system 20 is a single bed material feeding (e.g., 1×100% capacity) lock hopper system per gasification train, and can include bed material weigh hopper and bed additive weigh hopper where the bed material and bed additive are fed into the lock/surge hopper in which it is pressurized to system pressure with nitrogen. The bed material diverting screw conveyor at the bottom of the lock/surge hopper moves the bed material to at least one of the biomass feeding screw conveyors which feeds it into the gasifier 30.

In various embodiments, the syngas generation system 222 includes a gasifier 30 that is designed or configured for gasifying the biomass feed received from the biomass feeding system 10 and/or the bed material feeding system 20. In various embodiments, the gasifier 30 includes a natural gas-fueled start-up heater that is used to heat the reactor of the gasifier during startup of the gasifier reactor. In some implementations, the gasifier reactor may be designed to handle biomass at a rate of ranging from about 10,000 kg/h, 14,000 kg/h, 18,000 kg/h, 22,000 kg/h, 26,000 kg/h, 30,000 kg/h, 34,000 kg/h, 38,000 kg/h, 42,000 kg/h, 46,000 kg/h, 50,000 kg/h, 55,000 kg/h to about 60,000 kg/h, including values and subranges therebetween. In some aspects, the biomass rate can be from about 15,000 kg/h to about 50,000 kg/h, from about 20,000 kg/h to about 45,000 kg/h, from about 30,000 kg/h to about 40,000 kg/h, about 13,230 kg/h, about 40,000 kg/h, including values and subranges therebetween, of biomass at moisture from about 7, 8, 9, 10, 11, 12, 13, 14, 15, 16, 17, 18, 19, 20, 21, 22, 23, 24, 25, 26, 27, 28, 29, 30, 31, 32, 33, 34, to 35 wt. %, including values and ranges therebetween. In some aspects, the biomass has moisture in the range from about 7 wt. % to about 30 wt. %, from about 10 wt. % to about 25 wt. %, from about 15 wt. % to about 20 wt. %, about 17 wt. %, including values and subranges therebetween. In various embodiments, the biomass may be at a higher moisture of about 33, 34, 35, 36, 37, 38, 39, 40, wt. %, or higher, and it may be dried down to the aforementioned moisture levels (e.g., by feed dryers such as belt-type dryers where raw biomass is dried using hot air). During startup, air for biomass drying is supplied by a startup air system (e.g., outside the study battery limit) that includes an air compressor and an air receiver.

In various embodiments, the biomass feed is gasified by the gasifier reactor in the presence of oxygen (or air) and steam at pressure in the range from about 5 barg, 6 barg, 7 barg, 8 barg, 9 barg, 10 barg, 11 barg, 12 barg, 13 barg, 14 barg, to about 15 barg, including values and subranges therebetween, and temperature from about 650° C., 700° C., 750° C., 800° C., 825° C., 850° C., 875° C., 900° C., 950° C., 1000° C., 1050° C., to about 1100° C., including values and subranges therebetween. A non-limiting example of the gasifier 30 is a pressurized bubbling fluidized bed refractory lined pressure vessel. Both oxygen (or air) and steam are introduced to the gasifier 30. For example, both oxygen (or air) and steam are introduced through a valve system to multiple locations in the gasifier 30. In various embodiments, oxygen (or air) is supplied from battery limit and is preheated to temperature in the range from about 150° C., 160° C., 170° C., 177° C., 180° C., 190° C., 200° C., including values and subranges therebetween, in the oxygen preheater. The feedstock is devolatilized rapidly in the gasifier 30 while the remaining char is gasified and a portion of char is combusted to maintain the desired gasification temperature. Produced gases (syngas) exit the gasifier 30 at the top of the reactor. Entrained dust is at least substantially removed from the hot syngas in the cyclone and returned to the reactor's fluidized bed via the cyclone return pipe (e.g., dipleg).

In various embodiments, the syngas generation system 222 includes a tar removal system 60 that is configured to remove tar from the syngas produced by the gasifier 30 by thermal cracking. In the tar removal system 60, the fuel gas enters the tar removal burner (or hot oxygen burner), where the tar components and other unsaturated hydrocarbon compounds are converted into hydrogen and carbon monoxide. Reducing or eliminating heavier hydrocarbons aids with preventing their condensation in the downstream equipment and piping. Oxidation temperature is achieved by injecting oxygen and fuel gas to the tar removal burner.

In some embodiments, the tar removal burner utilizes recycled syngas that has been compressed downstream of the gasification island for fuel. Both syngas and molten solids flow downward through the tar removal vessel to the syngas cooler. In some instances, from about 4% to about 14% of the syngas produced by the syngas generation system 222 may be recycled or provided to the tar removal system 60 to serve as fuel for operating the tar removal system 60. As discussed below, in various embodiments, tail gas that is a byproduct of the post-gasification processes 108 is recycled to be used as fuel for the tar removal system 60 to remove tar from the syngas.

In various embodiments, the syngas generation system 222 includes a syngas cooler 70 that is configured to cool the syngas as well as that of spent fines associated therewith to about 575° C., about 550° C., about 534° C., about 525° C., about 500° C., about 475° C., about 450° C., or lower. The syngas cooler includes a boiler, a superheater and a steam drum. In some instances, the syngas cooler also includes an economizer. The recovered heat from the syngas cooler can be used to generate superheated high pressure steam (e.g., at temperature in the range from about 250° C., 275° C., 285° C., 290° C., 300° C., 325° C., to about 350° C., for example, about 288° C., at pressure in the range from about 35 barg, 36 barg, 37 barg, 38 barg, 39 barg, 40 barg, 41 barg, 42 barg, 43 barg, 44 barg, to about 45 barg, for example, about 41.4 barg. The steam from the syngas cooler can be utilized in gasifier 30, post-gasification processes 108, and other process units such as air separation unit or steam turbine.

In various embodiments, boiler feed water is sent to the steam drum of the syngas cooler 70 where it is preheated. The steam drum associated with syngas cooling has at least one blowdown stream. The spent fines disengage from the gas stream and drop by gravity into a water bath. The cooled wet spent fines are then sent to the wet spent fines removal system 50 of the syngas generation system 222. The water bath at the bottom of the syngas cooler 70 has a blowdown stream. In some instances, the syngas and the remaining spent fines leaving the syngas cooler 70 are further cooled via the addition of a quench water stream prior to entering the syngas filter 80 at temperature ranging from about 250° C., 260° C., 270° C., 280° C., 290° C., 300° C., 310° C., 320° C., 330° C., 340° C., to about 350° C., including values and subranges therebetween, for example about 295° C., 300° C., 305° C., etc.

In various embodiments, the syngas generation system 222 includes the syngas filter 80 that is configured to receive syngas and spent fines from the syngas cooler 70. The syngas filter is a candle filter unit including metal candle filter elements arranged in clusters and installed into a tube sheet. The filter candles are cleaned with carbon dioxide by back pulsing from the blowback tank. The filter unit is operated at system pressure and the pulsing gas is injected at an elevated temperature.

In various embodiments, the syngas generation system 222 includes a syngas scrubber 90 that is configured to receive the syngas from the syngas filter 80 and further cool the syngas to about 40° C., 41° C., 42° C., 43° C., 44° C., 45° C., 46° C., 47° C., 48° C., 49° C., or 50° C., including values and subranges therebetween. The syngas scrubber 90 removes part of the water vapor and remaining contaminants from the syngas and protects the syngas compression system 112 and the downstream processes from solids contamination in the event of tar removal burner or syngas filter 80 malfunction. In some instances, the scrubber has an inlet quench system where water is pumped by cooling pumps (e.g., 2×100%) through nozzles into the syngas feed stream just before entry to the scrubber. The gas is then cooled further through the first stage bed. In some instances, the scrubber water is circulated by circulation pumps (e.g., 2×100%) through a heat recovery heat exchanger to the top of the first stage bed. In the second stage, the gas is cooled through the second stage bed by recirculated water. In some instances, a process condensate stream is injected at the top of the syngas scrubber 90 to allow for additional chloride removal.

Chemicals can be added to the scrubber water to adjust the pH value of the water or enhance chloride removal and neutralize ammonia from the syngas. The raw-cooled saturated syngas from the syngas scrubber 90 is sent to the post-gasification process 108.

In various embodiments, the syngas generation system 222 includes solid removal systems 40, 100 that is configured to handle and store spent bed material and dry spent fines, etc. For example, the solid removal systems 40, 100 can include two separate solid removal systems including lock hoppers, conveyor hoppers and storage silos designed to handle the solid material from the gasifier 30 and syngas filter 80.

In some instances, spent bed material is removed through the bottom of the gasifier 30 using a water-cooled screw to a nitrogen-pressurized lock hopper. The spent bed material is conveyed pneumatically through a gasifier spent bed material conveyor hopper to the common gasifier spent bed material silo by using nitrogen or any other inert gas available.

Similar to the spent bed material, dry spent fines from the syngas filter 80 are removed using water-cooled screws and are passed through a lock hopper and conveyor hopper. A buffer hopper located after the cooling screw allows continuous operation of the screw. Dry spent fines from the syngas filter 80 are then loaded into a dry spent fines storage silo using nitrogen or any other dry inert gas available.

In various embodiments, the syngas generation system 222 also includes wet spent removal system 50 that is configured to receive the wet spent fines that drop in from the syngas cooler water bath. Water from this system is recycled back to the water in the syngas cooler via pump. The accumulated wet spent fines are then cooled, depressurized, and removed from the wet spent removal system 50.

In various embodiments, nitrogen, carbon dioxide, water, etc., that are used by the syngas generation system 222 to generate syngas can be provided by auxiliary systems that are coupled to the syngas generation system 222. For example, the auxiliary systems can include a nitrogen supply system, a carbon dioxide supply system, a water supply system, etc. The auxiliary systems can also include a heat exchange system. For instance, the nitrogen supply system can supply nitrogen from the battery limit which can be used as an inert gas in the syngas generation system 222 and as a fuel diluent for the hot oxygen burner during start-up. The nitrogen is supplied to the project at high pressure and low pressure. A buffer drum is used at each pressure to ensure adequate nitrogen is available for safe operation, start-up, and shutdown of the unit. The nitrogen from the buffer drums can flow to a low-pressure and a high-pressure nitrogen header that distributes nitrogen to nitrogen consumers.

The carbon-dioxide supply system provides sulfur free-CO2 to the syngas generation system 222 from an acid gas removal unit in the downstream process. This CO₂ stream is fed to high pressure and low pressure buffering drums in the carbon-dioxide supply system. CO₂ is distributed from these drums to the various users.

The water supply system includes a high-pressure cooling water system and a high-pressure sealing water system. The high-pressure cooling water system is used to cool the gasifier bottom spent bed material, the dry spent fines, and the three biomass feeding screws. The cooling water system is a closed-loop system operated at high pressure. The loop includes circulating pumps, a storage drum, and a cooling heat exchanger. The high-pressure sealing water system is used to supply water to the mechanical seals of the solids removal systems and biomass feeding screw shafts. The loop includes circulating pumps, a storage drum, and a cooling heat exchanger.

The heat exchange system of the auxiliary systems is a hot process heat exchange system including a hot process cooling water system that is a closed-loop system and uses a series of pumps, storage drum, and heat exchangers to exchange heat between portions of the facility. The hot process water supply cools the scrubber bottoms stream and the high pressure cooling water loop water, the heated process water is then available as a heat source for biomass feed drying, as needed.

Returning to FIG. 1, in various embodiments, the tar removal system 60 can use the tail gas that is generated as a by-product of the post-gasification process 108 as fuel for the removal of tar from the syngas. In a process model where the tar removal system was configured to use tail gas instead of syngas as fuel source, the amount of hydrogen produced at H2 separation system (PSA) outlet increased by 8-11%. In various embodiments, the scrubbed syngas from the gasifier 30 enters the syngas compressor inlet knock-out drum (KOD) to separate liquid entrained in the gas stream. A multistage compressor with interstage air coolers can be included. Water and condensate formed after each stage is removed via KODs downstream of the interstage coolers and sent to the sour water stripper unit. A syngas recycle stream is drawn out after the 2nd stage interstage KOD and recycled back to the gasifier 30. The compressed syngas is sent to a water-gas shift (e.g., two stage water-gas shift) and gas cooling unit.

In various embodiments, the scrubbed and compressed syngas undergoes a water shift process (e.g., multi-stage water shift process). For example, the scrubbed and compressed syngas is fed to the water-gas shift and gas cooling unit. A two-stage sour shift reactor can be used to maximize the production of hydrogen. The raw syngas feed can have high pressure steam added to it to maintain an optimal steam/CO ratio. It is then preheated in a reactor feed/effluent exchanger before being fed to the 1^{st} stage shift reactor. Syngas from the outlet of the 1^{st} stage shift reactor is cooled in a process steam generator followed by a feed/effluent exchanger prior to admitting it into the 2^{nd} stage shift reactor. The outlet gas from the 2^{nd} stage shift reactor is cooled further in multiple (e.g., four) exchangers.

The cooled, shifted syngas then is sent to the syngas KOD and then to the H₂S removal unit for syngas purification. In some instances, process condensate from the bottom of the syngas KOD is pumped, mixed with recycled water from the process wastewater treatment unit, and utilized as process steam within the water-gas shift unit via heat recovery from the shifted syngas. The process steam is separated from any condensate in the process steam drums, and a final hot process condensate stream is purged and routed to the condensate steam sparger from where it is sent to the process wastewater treatment unit.

The syngas is further processed to separate out H₂S, CO₂, and H₂ (e.g., via pressure swing adsorption). To remove H₂S, a H₂S removal unit scavenger package can be utilized. The cooled syngas from the 2nd stage shift reactor is sent to the H₂S removal unit scavenger package. The package can have two adsorbent beds which use a granular solid containing iron and other metal oxides to remove H₂S. As the gas passes through the beds, H₂S is adsorbed for syngas purification. An H₂S analyzer located at the outlet of the skid measures the H₂S concentration of the syngas leaving the system. The clean syngas outlet from the syngas H₂S scavenger and H₂S removal unit is targeted to contain less than about 0.3, 0.2, 0.1, 0.05 ppmv (parts per million by volume), or lower, of H₂S. The manual valving and piping configuration between the dual beds allows operation in a lead-lag design arrangement, including but not limited to single bed operation with maintenance or change-out of the other, first bed as lead bed and second bed as lag bed, or second bed as lead bed and first bed as lag bed.

For CO₂ removal, the CO₂ removal unit can utilize an amine-based CO2 removal system with activated MDEA (methyl diethanolamine) solvents and/or a physical solvent that uses propylene carbonate for the removal of CO₂ for recovery from hydrogen-rich syngas. The captured CO₂ stream has sufficient purity for carbon sequestration. After the H₂S removal unit, syngas enters the CO₂ removal unit. In some instances, the wet syngas is first dehydrated with a triethylene glycol (TEG) dehydration package. Dehydrated feed gas from the TEG absorber is cooled against treated gas in the feed/treated gas exchanger. The cooled gas (e.g., fed at the bottom) is then contacted with cold lean solvent (e.g., fed at the top) in the physical solvent absorber to remove CO₂. The low operating temperature increases the solvent loading capacity, thereby reducing the solvent circulation rate.

Rich solvent leaving the absorber bottom is regenerated via a series of flashes at decreasing pressure. The first pressure letdown is through a hydraulic turbine. Flash gas from the high pressure (HP) flash drum contains significant amounts of hydrogen and is recycled back to the front of the CO₂ removal unit to improve the overall recovery. The HP flash gas is compressed by the recycle compressor and cooled by the recycle cooler. Rich solvent from the HP flash drum flows on level control to the low pressure (LP) flash drum where the pressure is further reduced. Solvent from the LP flash drum flows on level control to the vacuum flash drum. Lean solvent from the vacuum flash drum is pumped on flow control by the booster pump followed by the circulation pump through the lean solvent chiller (and refrigeration/chiller package), then back to the absorber. Flash gas from the LP flash drum is combined with flash gas from the vacuum flash drum then compressed by the vacuum compressor. The resulting dry CO₂ product at about 95, 96, 97, 98, 99, 99.6, 99.7, 99.8, 99.9 mol % purity is sent to the CO₂ Compression unit.

With respect to the compression of CO₂, dry CO₂ from the CO₂ removal unit is sent to the CO₂ compression unit where CO₂ is compressed to the required pressure using a four-stage compressor before sending to pipeline for sequestration. Though the CO₂ from the CO₂ removal unit is expected to be completely dry, an inlet suction KOD is considered upstream of the compressor 1st stage to knock out any potential water that may get carried during an upset scenario. Interstage air coolers and aftercooler (e.g., at the outlet of the 4th stage) are installed to maintain the correct temperature. Two intermediate recycle streams are withdrawn after the 2nd and 3rd stages, which are recycled back to the Gasification System. A CO₂ metering system is installed at the outlet of the compressor before the compressed CO₂ is sent to pipeline for sequestration.

The clean syngas from the CO₂ removal unit is sent to the H₂ Pressure Swing Adsorption (PSA) unit. The PSA unit is provided to obtain a high purity hydrogen product from the hydrogen-rich syngas stream. The PSA unit selectively adsorbs impurities (CH₄, N₂, CO, CO₂) in the feed. The impurities are desorbed by lowering the adsorber pressure from the feed pressure to the tail gas pressure. The hydrogen is not adsorbed and thus recovered at a high purity of about 99.6, 99.7, 99.8, 99.9, 99.95, 99.96, 99.97, 99.98, 99.99 mol %, or higher. The resultant hydrogen is sent to the H₂ compression or liquefaction unit, with tail-gas, which can be low-pressure, produced as a by-product.

In some embodiments, the tail gas, containing some H₂, CH₄, N₂, CO, and traces of CO₂ produced in the process, is sent to the PSA tail gas boiler in the power generation and boiler unit. In some embodiments, the tail gas by-product can be recycled or provided to the tar removal system for use as fuel in the tar removal process in gasification 106. The PSA tail gas can be low in CO₂ content due to the upstream CO₂ removal unit, which removes CO₂ from the clean syngas before it enters the PSA unit. Thus, its heating value is relatively high for use as fuel for the tar removal unit or system 60. In some instances, the tail gas may be compressed before being routed to the tar removal system. That is, in addition to or instead of using the tail gas for power generation and fueling the boiler, the tail gas may be provided to the tar removal system 60 (FIG. 2) so that the tar removal system 60 can operate using the tail gas by-product as fuel to remove or reduce the tar in the syngas generated by the syngas generation system 222. In some instances, recycled syngas and/or natural gas may also be used as fuel to power the tar removal system 60. In some instances, no recycled syngas or natural gas may be used as fuel but instead the recycled tail gas may be used as fuel for the tar removal system 60 to remove tar from syngas.

In various embodiments, the tail gas that is provided to the tar removal system 60 as fuel for removing tar may be at temperature ranging from about 20° C., 25° C., 30° C., 35° C., 40° C., 45° C., 50° C., 55° C., to about 60° C., including values and subranges therebetween. In some aspects, the temperature can be in the range from about 25° C. to about 50° C., including values and subranges therebetween. Further, the pressure can be in the range from about 0.5 barg, 1 barg, 2 barg, 3 barg, 4 barg, 5 barg, 6 barg, 7 barg, 8 barg, 9 barg, to about 10 barg, including values and subranges therebetween, for example, about 2 barg, about 3 barg, about 5 barg. In some embodiments, the mass rate can range from about 100 kg/h to about 2500 kg/h, including values and subranges therebetween.

### Examples

Tables 1-7 provide example illustrations of the advantages of recycling a tail gas that is a by-product of a syngas (e.g., hydrogen) generation process as fuel for removing tar gas from the syngas, i.e., as fuel for a tar removal system of the syngas generation system executing the syngas generation process. Table 1 compares exemplary experimental values of the various parameters associated with the generation of syngas in “tail gas recycle” and “base case” scenarios, where tail gas is and is not, respectively, recycled for use as fuel for the tar removal system of the syngas generation system. Table 2 shows the values of the “tail gas recycle” scenario as a percentage those of the “base case” scenario. Table 1 and Table 2 demonstrate that, in some embodiments, recycling tail gas to serve as fuel for removing tar from syngas generates more hydrogen (e.g., by about 8.7%), demonstrating the benefits of recycling tail gas. Carbon dioxide capture increases as well (e.g., by about 2.2%). Furthermore, despite the increase in power consumption, the carbon intensity decreases due to more CO₂ being captured. The recycling of tail gas also improves the thermal efficiency, increasing by about 7.1%.

Tables 3 and 4 show energy balance of the “base case” scenario and the “tail gas recycle” scenario, respectively.

TABLE 1
Exemplary experimental values of various parameters
associated with the generation of syngas in “tail
gas recycle” and “base case” scenarios.

| | | | Tail Gas |
|---|---|---|---|
| Parameter | Unit | Base Case | Recycle |
| Hydrogen Produced | t/year | 6,561 | 7,133 |
| CO₂ captured | t/year | 133,952 | 136,958 |
| Thermal efficiency | % | 42 | 45 |
| Trucking emissions | t_{CO2e}/year | 1,287 | 1,287 |
| Electricity emissions | t_{CO2e}/year | 21,910 | 22,819 |
| Carbon Intensity | t_{CO2e}/t_{H2} | −16.88 | −15.82 |

TABLE 2
Exemplary values of a “tail gas recycle” scenario as
a percentage of those “base case” scenario.

| | | Tail Gas |
|---|---|---|
| | | Recycle/Base |
| Parameter | Unit | Case |
| Hydrogen Produced | % | 108.7 |
| CO₂ captured | % | 102.2 |
| Thermal efficiency | % | 107.1 |
| Trucking emissions | % | 100 |
| Electricity emissions | % | 104.1 |
| Carbon Intensity | % | 93.7 |

TABLE 3
Energy balance of an exemplary “base case” scenario.

| | | | |
|---|---|---|---|
| | Sensible + | | |
| HHV | Latent | Power | Total |

Heat In (kJ/hr)

| | | | | |
|---|---|---|---|---|
| Biomass | 138,040,222 | | | 138,040,222 |
| Scrubber Pump | | | 65,355 | 65,355 |
| Syngas Compression | | | 3,861,408 | 3,861,408 |
| Water from SWS | 936,707 | | | 936,707 |
| Shift Pump | | | 12,356 | 12,356 |
| Recycle Compressor | | | 260,560 | 260,560 |
| Vacuum Compressor | | | 1,264,592 | 1,264,592 |
| Propylene Carbonate | | | 2,257,571 | 2,257,571 |
| Pump | | | | |
| TEG Dryer | | 58,677 | | 58,677 |
| CO₂ Compressor | | | 7,573,702 | 7,573,702 |
| H₂ Compressor | | | 5,746,115 | 5,746,115 |
| PSA | | 3,184 | | 3,184 |
| Total | 138,976,928 | 61,860 | 20,041,659 | 160,080,447 |

Heat Out (kJ/hr)

| | | | | |
|---|---|---|---|---|
| Scrubber cooler | | 25,697,999 | | 25,697,999 |
| Syngas Compression | | 2,241,406 | | 2,241,406 |
| Intercooling | | | | |
| Shift Cooling | | 15,832,077 | | 15,832,077 |
| H2S stream | 134,354 | | | 134,354 |
| Propylene Carbonate | | 1,367,285 | | 1,367,285 |
| Chiller | | | | |
| Recycle Hydrogen | | 197,517 | | 197,517 |
| Cooler | | | | |
| Hydraulic Turbine | | | 1,849,067 | 1,849,067 |
| CO₂ Compressor | | 10,443,667 | | 10,443,667 |
| Intercooling | | | | |
| CO₂ to Storage | 648,925 | | | 648,925 |
| H₂ Compressor | | 5,238,332 | | 5,238,332 |
| Intercooling | | | | |
| H₂ Product | 96,149,340 | | | 96,149,340 |
| Flue Gas | 398,990 | | | 398,990 |
| Total | 97,331,608 | 61,018,283 | 1,849,067 | 160,198,959 |
| Unaccounted energy | | | | 118,512 |
| Unaccounted energy | | | | 0.07 |
| (%) | | | | |

TABLE 4
Energy balance of an exemplary “tail gas recycle” scenario.

| | | | |
|---|---|---|---|
| | Sensible + | | |
| HHV | Latent | Power | Total |

Heat In (kJ/hr)

| | | | | |
|---|---|---|---|---|
| Biomass | 138,040,222 | | | 138,040,222 |
| Scrubber Pump | | | 65,369 | 65,369 |
| Syngas Compression | | | 4,087,088 | 4,087,088 |
| Water from SWS | 936,707 | | | 936,707 |
| Shift Pump | | | 11,953 | 11,953 |
| Recycle Compressor | | | 269,554 | 269,554 |
| Vacuum Compressor | | | 1,264,450 | 1,264,450 |
| Propylene Carbonate | | | 2,257,812 | 2,257,812 |
| Pump | | | | |
| TEG Dryer | | 60,318 | | 60,318 |
| CO₂ Compressor | | | 7,726,825 | 7,726,825 |
| H₂ Compressor | | | 6,258,378 | 6,258,378 |
| Recycled Tail Gas | | | 199,822 | 199,822 |
| Compressor | | | | |
| PSA | | 4,514 | | 4,514 |
| Total | 138,976,928 | 64,832 | 22,141,252 | 161,183,012 |
| Heat out (kJ/hr) | | | | |
| Scrubber cooler | | 25,647,528 | | 25,647,528 |
| Syngas Compression | | 2,405,472 | | 2,405,472 |
| Intercooling | | | | |
| Shift Cooling | | 16,029,097 | | 16,029,097 |
| H2S stream | 134,393 | | | 134,393 |
| Propylene Carbonate | | 1,367,368 | | 1,367,368 |
| Chiller | | | | |
| Recycle Hydrogen | | 204,784 | | 204,784 |
| Cooler | | | | |
| Hydraulic Turbine | | | −269,554 | −269,554 |
| CO₂ Compressor | | 10,647,381 | | 10,647,381 |
| Intercooling | | | | |
| CO₂ to Storage | 684,335 | | | 684,335 |
| H₂ Compressor | | 5,701,912 | | 5,701,912 |
| Intercooling | | | | |
| H₂ Product | 104,529,698 | | | 104,529,698 |
| Flue Gas | 244,839 | | | 244,839 |
| Total | 105,593,264 | 62,003,542 | −269,554 | 167,327,252 |
| Unaccounted energy | | | | 6,144,240 |
| Unaccounted energy | | | | 3.81 |
| (%) | | | | |

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method, comprising:
receiving a biomass feed at a biomass feed inlet of a synthesis gas (syngas) generation system;
gasifying, using a gasifier of the syngas generation system, the biomass feed to produce syngas under a condition resulting in generation of a tar by-product, the syngas generation system including a tar removal system configured to remove the tar by-product from the syngas, a post-gasification process generates a tail gas by-product;
providing at least a portion of the tail gas by-product to the tar removal system of the syngas generation system; and
operating the tar removal system using the at least a portion of the tail gas by-product as fuel to remove or reduce the tar in the syngas.

2. The method of claim 1, further comprising increasing the concentration of at least one tail gas by-product component by a separation process prior to providing at least a portion of the tail gas by-product to the tar removal system of the syngas generation system.

3. The method of claim 2, wherein increasing the concentration of at least one tail gas by-product component comprises employing a separation technique selected from pressure swing adsorption (PSA), cryogenic distillation, and membrane separation.

4. The method of claim 2, wherein the increased-concentration component is an oxidizable component.

5. The method of claim 2, wherein the oxidizable component is selected from hydrogen, carbon monoxide, and a combination thereof.

6. The method of claim 1, wherein the tail gas by-product provided to the tar removal system of the syngas generation system is not subjected to a component concentration-increasing step.

7. The method of claim 1, wherein providing at least a portion of the tail gas by-product to the tar removal system of the syngas generation system increases a net amount of syngas for post-gasification process.

8. A synthesis gas (syngas) generation system, comprising:
a biomass feed inlet configured to receive a biomass feed;
a gasifier in communication with the biomass feed inlet and configured to receive and gasify the biomass feed to produce synthesis gas under a condition resulting in generation of a tar by-product, a post-gasification process generates a tail gas by-product;
a transport system configured to transport the tail gas by-product of the post-gasification process to a tar removal system; and
the tar removal system configured to use the tail-gas by-product received via the transport system as fuel to remove the tar by-product from the synthesis gas.

9. The system of claim 8, wherein the transport system comprises a component-separation apparatus to increase the concentration of at least one tail gas by-product component by a separation process.

10. The system of claim 9, wherein the component-separation apparatus increases the concentration of at least one tail gas by-product component by employing a separation technique selected from pressure swing adsorption (PSA), cryogenic distillation, and membrane separation.

11. The system of claim 9, wherein the increased-concentration component is an oxidizable component.

12. The system of claim 11, wherein the oxidizable component is selected from hydrogen, carbon monoxide, and a combination thereof.

13. The system of claim 8, wherein the system does not comprise a component-separation apparatus to increase the concentration of at least one tail gas by-product component.

14. The system of claim 8, wherein the transport system enables the syngas generation system to produce an increased net amount of syngas as compared to a comparable syngas generation system lacking a tail gas transport system.
